(19) United States
(12) Patent Application Publication
(10) Pub. No.: US 2010/0321926 A1
(43) Pub. Date: Dec. 23, 2010

(54) BACKLIGHT FOR LIQUID CRYSTAL DISPLAY

(75) Inventor: Mitsuhiro Takeba, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/865,416

(22) PCT Filed: Dec. 1, 2008
(86) PCT No.: PCT/JP2008/071776

§ 371 Date: Jul. 30, 2010

(30) Foreign Application Priority Data
Apr. 10, 2008 (JP) 2008-102235

(51) Int. Cl. G02F 1/13357

(52) U.S. Cl. 362/97.2

(57) ABSTRACT

Light source lamps can be held at different interval by a single kind of lamp clip. A straight tube light source lamp (3) arranged on the surface of a backlight chassis (1) is held by a lamp clip (20) fixed to the backlight chassis (1). The lamp clip (20) comprises a base (21) placed on the surface of the backlight chassis (1), and lamp grippers (22) formed on the opposite sides of the base (21). A plurality of lamp grippers (22) are formed on both sides of the base (21) at respective intervals different from each other. A through hole (11) for passing the lamp gripper (22) on the surface of the lamp clip (20) not pertaining to lamp holding is formed in the backlight chassis (1). The lamp gripper (22) passed through the through hole (11) serves to fix the lamp clip (20) to the backlight chassis (1).

### TECHNICAL FIELD

The present invention relates to backlights for a liquid crystal display device.

### BACKGROUND ART

With some exceptions, in liquid crystal display devices, a liquid crystal display panel is combined with a backlight. In large liquid crystal display devices such as ones incorporated in television sets, with a view to distributing required amount of light in every corner of a screen, a plurality of straight tube light source lamps are often arrayed at a predetermined interval in a backlight chassis. An example of the structure of such large liquid crystal display devices is shown in FIG. 20.

FIG. 20 is an exploded perspective view of components of a liquid crystal display device. Here, the components are arranged assuming the liquid crystal display device is to be assembled such that a display surface faces up. What lies at the bottom is a backlight chassis 1 formed of sheet metal. Over the backlight chassis 1, a reflector sheet 2 is laid. Over the reflector sheet 2, a plurality of light source lamps 3 for backlighting are arranged. Although straight type cold cathode tubes are generally used as light source lamps for backlighting, it is also possible to use any other types of lamps, for example, hot cathode tubes, xenon lamps, and the like.

Over the light source lamps 3, an optical sheet group 4 is arranged, the optical group 4 including a diffusion plate, a lens sheet, a polarizing reflection sheet, a diffusion sheet, and the like. The optical sheet group 4 is used for adjusting the characteristics of light which the light source lamps 3 emit.

The optical sheet group 4 is fitted to the backlight chassis 1 with a rectangular frame 5. Over the frame 5, a liquid crystal display panel 6 is arranged. At the top tier, a rectangular bezel 7 is arranged. The bezel 7 fixes the liquid crystal display panel 6 with respect to the backlight chassis 1, and also serves to improve the appearance of the liquid crystal display device as a whole.

The backlight chassis 1 is rectangular as seen in a plan view, and has the shape of a tray with its edge erected at its periphery. At both ends of the backlight chassis 1, fitting portions 9 are formed for sockets 8 that are fitted to end parts of the light source lamps 3. Each of the fitting portions 9 is a through hole with a predetermined shape, into which two sockets 8 are inserted. A plurality of fitting portions 9 are formed in line along the shorter sides of the backlight chassis 1. The sockets 8 are electrically connected to a control circuit board in a control box (not shown) provided at the bottom of the backlight chassis 1.

Each of the light source lamps 3 is long, and sounds when vibration is transmitted to it. Moreover, if an impact force acts on the light source lamp 3, there is a risk of breakage. To avoid this, a middle part of the light source lamp 3 is fixed to the backlight chassis 1 with a lamp clip 20.

The structure of a lamp clip 20 is shown in FIG. 22. In the lamp clip 20, a lamp gripper 22 with the shape of “C” open at the top is provided on the upper surface of a plate-shaped base 21 which is rectangular as seen in a plan view. The lamp gripper 22 is for holding a light source lamp 3 with its elasticity; a total of two lamp grippers 22 are provided on the base 21, one near either end of the base 21 in its longitudinal direction. On the lower surface of the base 21, two fitting studs 23 having the shape of a snap stud with a bulged head portion and a slotted groove are formed in the longitudinal direction of the base 21 at an interval. The whole lamp clip 20 is integrally formed of an elastic synthetic resin.

In the backlight chassis 1 and the reflector sheet 2 attached on the upper surface of the backlight chassis 1, fitting holes 10 for the lamp clip 20 are formed. The fitting holes 10 are for snap-engaging the fitting studs 23, and are arranged in pairs. When a fitting stud 23 is pressed against a fitting hole 10 from above, the bulged head portion of the fitting stud 23 shrinks and passes through the hole. When the head portion of the fitting stud 23 comes out from the lower surface of the backlight chassis 1, it springs back and bulges. In this way, the lamp clip 20 is fixed.

As shown in FIG. 21, a light source lamp 3 is held by a lamp clip 20 at two places somewhere in the middle of itself. One lamp clip 20 holds two light source lamps 3. Thus, the light source lamps 3 are in a pair and, along the length direction of the pair of light source lamps 3, two lamp clips 20 are arranged at an interval.

Holding middle parts of the light source lamp 3 with the lamp clip 20 prevents the light source lamp 3 from vibrating and sounding. Moreover, even if an impact acts on the backlight chassis 1, it is less likely that the light source lamp 3 bends and breaks.

The lamp clip 20 is formed of a synthetic resin with poor thermal conductivity; even so, a predetermined percentage of heat generated by the light source lamp 3 is transmitted to the backlight chassis 1. As a result of heat being taken away, the brightness of the light source lamp 3 is reduced at places where the lamp clips 20 are. If the lamp clips 20 are aligned in the direction of the shorter side of the backlight chassis 1, a visible band with lower brightness appears. Thus, to prevent this, the positions of the lamp clips 20 are spread out. Specifically, as shown in FIG. 21, between adjacent pairs of light source lamps 3, the lamp clips 20 are so located as to deviate in the length direction of the light source lamp 3, so that the lamp clips 20 are in a staggered arrangement. In this way, parts with lower brightness are spread out, and become less annoying.

Examples of the lamp clip described above are disclosed in Patent Documents 1 and 2.

### Patent Document 1: JP-A-2006-32358

### Patent Document 2: JP-A-2005-19420

### DISCLOSURE OF THE INVENTION

### Problems to be Solved by the Invention

The interval of lamp grippers in a lamp clip may not be the same with any liquid crystal display devices. The required interval differs depending on the liquid crystal display device. In FIG. 22, the interval of lamp grippers 22 is “A”; whereas in FIG. 23, a lamp clip 20 is shown in which lamp grippers 22 are arranged at an interval B narrower than the interval A. Not only the interval of the lamp grippers 22, but also the interval of fitting studs 23 is different. Since there is no interchangeability between the lamp clip 20 shown in FIG. 22 and that shown in FIG. 23, two types of lamp clips 20 need to be prepared, resulting in costly manufacturing.

The present invention is devised in view of the above problem. An object of the invention is to provide a backlight for a liquid crystal display device, which is so structured as to satisfy the needs for holding light source lamps at different intervals, with a lamp clip of a single type.

### Means for Solving the Problem

To achieve the above object, according to the present invention, in a backlight for a liquid crystal display device, a straight tube light source lamp arranged at a surface of a backlight chassis is held by a lamp clip fixed to the backlight chassis. Here, the lamp clip includes a base placed on a surface of the backlight chassis, and a lamp gripper formed on each of opposite surfaces of the base. A plurality of the lamp grippers are respectively formed on each of the opposite surfaces of the base at respective intervals that differ depending on which surface the lamp grippers belong to. In the backlight chassis, there are formed through holes for letting pass therethrough the lamp grippers on one of the opposite surfaces of the lamp clip, the surface being the one that does not take part in lamp holding. The lamp grippers that have passed through the through holes serve to fix the lamp clip to the backlight chassis.

With this structure, the lamp clip can adapt to backlights adopting different settings for the interval of lamps by simply turning the lamp clip upside down and fixing it to the backlight chassis. Thus, there is no need to prepare two types of lamp clips, and advantageously, only one type of mold is needed. This reduces the costs of production and storage of components, and simplifies assembly work.

Moreover, according to the invention, in the backlight for a liquid crystal display device described above, the lamp grippers are provided in different numbers between each of the opposite surfaces of the base.

With this structure, the lamp clip can adapt to two types of backlight, one requiring a large number of light source lamps, and the other not requiring such a large number of light source lamps.

Moreover, according to the invention, in the backlight for a liquid crystal display device described above, an engaging protrusion is formed on at least one of the lamp grippers that pass through the through holes. By the engaging protrusion being engaged with an edge of the through holes, the lamp clip is fixed to the backlight chassis.

With this structure, by engaging the engaging protrusion with the edge of the through holes, it is possible to surely fit the lamp clip.

Moreover, according to the invention, in the backlight for a liquid crystal display device described above, among the lamp grippers that pass through the through holes, the lamp grippers with the engaging protrusion and the lamp grippers without the engaging protrusion coexist.

With this structure, not all the lamp grippers that pass through the through holes require engaging work of the engaging protrusion. Since engaging work can be omitted for some lamp grippers, it is possible to speed up the fixing work of the lamp clip. With respect to the lamp grippers without the engaging protrusions, there are advantages such as a simplified structure of a mold and reduction of molding material.

Moreover, according to the invention, in the backlight for a liquid crystal display device described above, with respect to the lamp grippers having the engaging protrusion, each lamp gripper includes two engaging protrusions. The two engaging protrusions project in opposite directions from each other.

With this structure, it is possible to fit the lamp grippers with the engaging protrusion firmly to the through holes. It is also possible to adopt a structure in which the lamp clip is fixed simply by engaging the engaging protrusions of one lamp gripper with the edge of the through holes.

Moreover, according to the invention, in the backlight for a liquid crystal display device described above, with respect to the lamp grippers having the engaging protrusion, only one engaging protrusion is provided for each lamp gripper.

With this structure, since the lamp gripper is provided with only one engaging protrusion, the structure of a mold is simplified, and molding material is reduced.

Moreover, according to the invention, in the backlight for a liquid crystal display device described above, a support column for supporting an optical sheet group arranged at a rear of a liquid crystal display panel is formed on one or both of the opposite surfaces of the base.

With this structure, it is possible to keep appropriate distance between the optical sheet group and the liquid crystal display panel, and to reduce unevenness in images.

### ADVANTAGES OF THE INVENTION

With the present invention, it is possible to properly use one lamp clip in two ways. Thus, it is possible to cope with another type of liquid crystal display device with a relatively small number of types of lamp clips, to reduce the costs of production and storage of the lamp clip, and moreover, to simplify assembly work.

### BRIEF DESCRIPTION OF DRAWINGS

FIG. 1 A sectional view of a part of a liquid crystal display device according to a first embodiment of the present invention.

FIG. 2 A sectional view of a part of the liquid crystal display device according to the first embodiment, with a backlight chassis of a different type.

FIG. 3 A sectional view of a part of the liquid crystal display device according to the first embodiment, illustrating that it is impossible to fit a lamp clip unless the lamp clip is in a proper orientation with respect to a backlight chassis.

FIG. 4 Another sectional view of a part of the liquid crystal display device according to the first embodiment, illustrating that it is impossible to fit a lamp clip unless the lamp clip is in a proper orientation with respect to a backlight chassis.

FIG. 5 A sectional view of a part of a liquid crystal display device according to a second embodiment of the invention.

FIG. 6 A sectional view of a part of the liquid crystal display device according to the second embodiment, with a backlight chassis of a different type.

FIG. 7 A sectional view of a part of a liquid crystal display device according to a third embodiment of the invention.

FIG. 8 A sectional view of a part of the liquid crystal display device according to the third embodiment, with a backlight chassis of a different type.

FIG. 9 A sectional view of a part of a liquid crystal display device according to a fourth embodiment of the invention.

FIG. 10 A sectional view of a part of the liquid crystal display device according to the fourth embodiment, with a backlight chassis of a different type.

FIG. 11 A sectional view of a part of a liquid crystal display device, illustrating a problem that can arise in the fourth embodiment.

FIG. 12 A sectional view of a part of a liquid crystal display device, showing a solution to the problem shown in FIG. 11.

FIG. 13 A sectional view of a part of a liquid crystal display device according to a fifth embodiment of the invention.

FIG. 14 A sectional view of a part of a liquid crystal display device, showing a modified embodiment of the fifth embodiment.

FIG. 15 A sectional view of a part of a liquid crystal display device according to a sixth embodiment of the invention.

FIG. 16 A sectional view of a part of a liquid crystal display device, showing a modified embodiment of the sixth embodiment, with a backlight chassis of a different type.

FIG. 17 A sectional view of a part of a liquid crystal display device according to a seventh embodiment of the invention.

FIG. 18 A sectional view of a part of a liquid crystal display device according to an eighth embodiment of the invention.

FIG. 19 A sectional view of a part of the liquid crystal display device according to the eighth embodiment, with a backlight chassis of a different type.

FIG. 20 An exploded perspective view of components of a conventional liquid crystal display device.

FIG. 21 A plan view of a conventional backlight chassis.

FIG. 22 A sectional view of a part of the conventional liquid crystal display device.

FIG. 23 A sectional view of a part of the conventional liquid crystal display device fitted with a lamp clip different from that shown in FIG. 22.

### LIST OF REFERENCE SYMBOLS

1 backlight chassis
2 reflector sheet
3 light source lamp
4 optical sheet group
6 liquid crystal display panel
11, 12 through hole
20 lamp clip
21 base
22 lamp gripper
24 engaging protrusion
25 support column

### BEST MODE FOR CARRYING OUT THE INVENTION

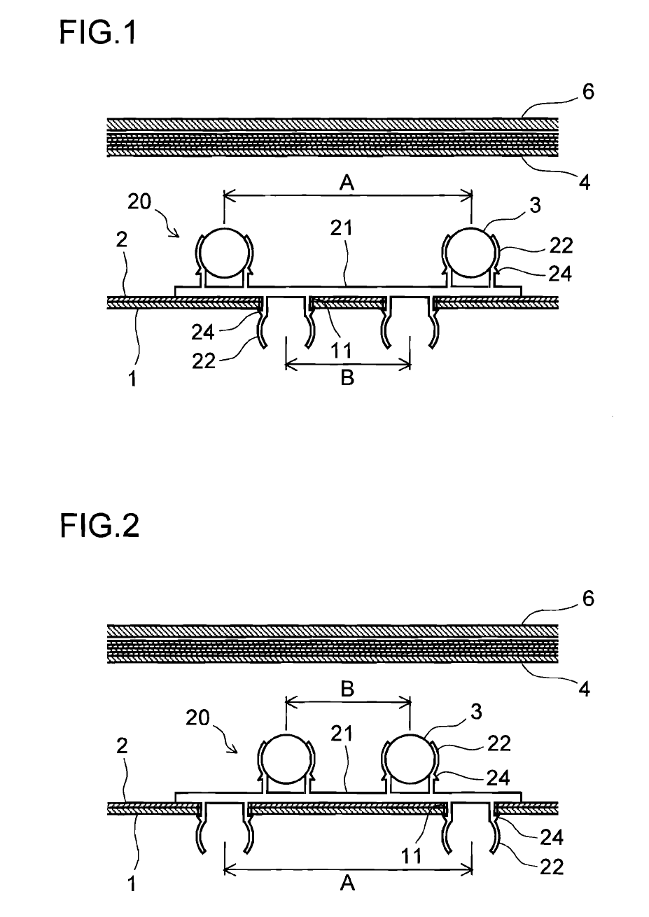

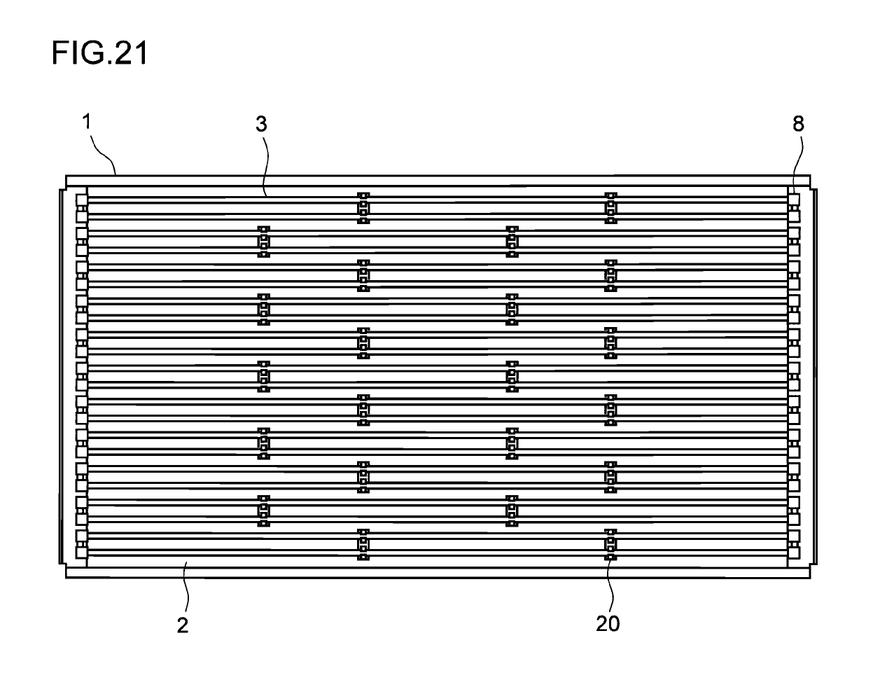

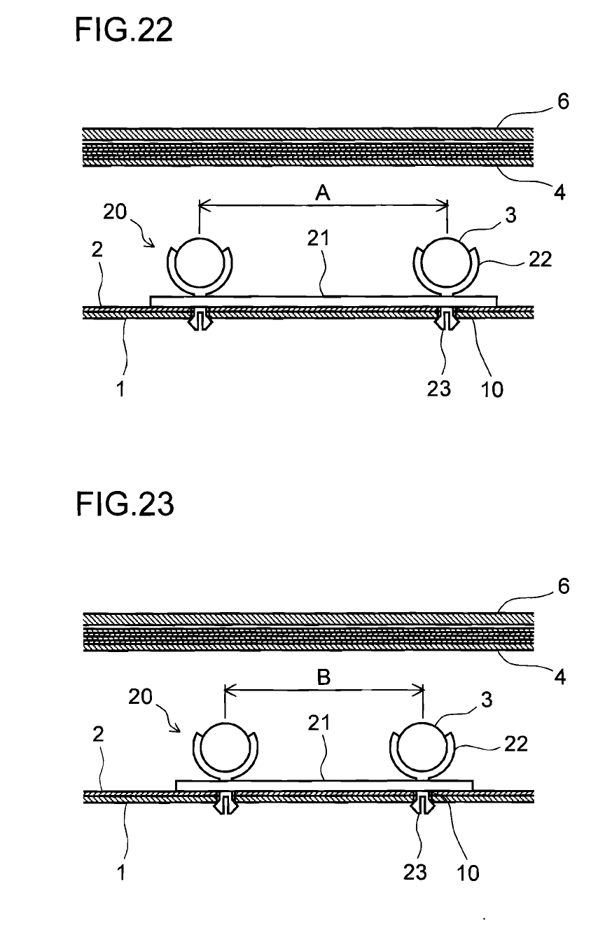

A first embodiment of the present invention is shown in FIGS. 1 to 4. In describing the first embodiment, such components as find their counterparts in the conventional structure shown in FIGS. 20 to 23 are identified by common reference signs used in FIGS. 20 to 23, and no description of them will be repeated. This applies also to a second and other embodiments.

In a lamp clip 20 according to the first embodiment, two lamp grippers 22 are formed integrally on each of opposite surfaces of a base 21. The lamp grippers 22 are each formed by two arms each having a straight root portion and a curved portion, and the two arms are arranged at an interval with concave surfaces of the curved portions facing each other. The lamp gripper 22 holds a straight tube light source lamp 3 by gripping it between two concave surfaces of the curved portions. The lamp gripper 22 also serves to fix the lamp clip 20 to a backlight chassis 1. On each arm of the lamp gripper 22, there is formed an engaging protrusion 24 that projects outward from a border portion between the straight root portion, which stands from the base 21, and the curved portion. Two engaging protrusions 24 are provided in each of the lamp grippers 22, and they project in the opposite direction from each other.

On one surface of the base 21, the lamp grippers 22 are arranged closer to both ends of the base 21 at an interval A. On the opposite surface of the base 21, the lamp grippers 22 are arranged closer to the middle of the base 21 at an interval B narrower than the interval A.

When the lamp clip 20 is placed on the backlight chassis 1 with the lamp grippers 22 at the interval A at the top, a setting is achieved in which light source lamps 3 are arranged at the interval A. When the lamp clip 20 is turned upside down and placed on the backlight chassis 1 with the lamp grippers 22 at the interval B at the top, a setting is achieved in which the light source lamps 3 are arranged at the interval B.

In a backlight adopting the setting in which the light source lamps 3 are arranged at the interval A, as shown in FIG. 1, there is used a combination of the backlight chassis 1 and a reflector sheet 2 that are provided with through holes 11 for letting the lamp grippers 22 at the interval B pass through.

In a backlight adopting the setting in which the light source lamps 3 are arranged at the interval B, as shown in FIG. 2, there is used a combination of the backlight chassis 1 and the reflector sheet 2 that are provided with through holes 11 for letting the lamp grippers 22 at the interval A pass through.

Each of the through holes 11 is a rectangular hole with a size just enough to let a root part of a lamp gripper 22 pass through. When the tip of the lamp gripper 22 is pressed against the through hole 11, the arms deflect inward and the engaging protrusion 24 passes through the through hole 11. When the engaging protrusions 24 pass through the through hole 11, the arms spring back and restore their original shape, and the engaging protrusions 24 are caught by the edge of the through hole 11. In this way, the lamp clip 20 is fixed to the backlight chassis 1. Since the engaging protrusions 24 engage with the edge of the through hole 11, the lamp clip 20 is surely attached to the backlight chassis 1 without it coming off. To prevent unstableness of the lamp clip 20 in a fitted state, the distance from the base 21 to the engaging protrusion 24 is set to be approximately equal to the thicknesses of the backlight chassis 1 and the reflector sheet 2 combined together.

As described above, by turning the lamp clip 20 upside down, it is possible to cope with two types of combinations of the backlight chassis 1 and the reflector sheet 2 by use a lamp clip 20 of one type. Thus, die cost can be cut down, making it possible to reduce the cost of production and storage of the components, and to simplify assembling work.

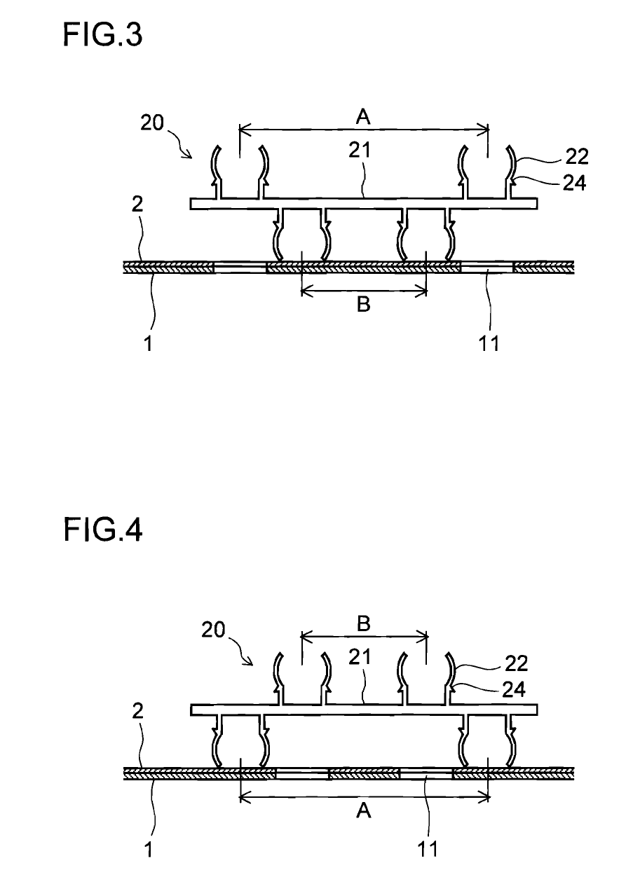

With the structure of the first embodiment, if an attempt is made to fit the lamp clip 20 shown in FIG. 1, namely the lamp clip 20 in which the lamp grippers 22 at the interval B project from the lower surface, to the combination of the backlight chassis 1 and the reflector sheet 2 in FIG. 2, namely the combination of the backlight chassis 1 and the reflector sheet 2 that are provided with the through holes 11 at the interval A, it ends in failure as shown in FIG. 3. In addition, if an attempt is made to fit the lamp clip 20 shown in FIG. 2, namely the lamp clip 20 in which the lamp grippers 22 at the interval A project from the lower surface, to the combination of the backlight chassis 1 and the reflector sheet 2 in FIG. 1, namely the combination of the backlight chassis 1 and the reflector sheet 2 that are provided with the through holes 11 at the interval B, it ends in failure as shown in FIG. 4. Thus, it is impossible to fit the lamp clip 20 to the backlight chassis 1 unless the surface orientation is correct, and therefore improper fixing of the lamp clip 20 is avoided.

In the structure of the first embodiment, since two engaging protrusions 24 are provided in each of the lamp grippers 22, it is possible to firmly fit the lamp grippers 22 to the through holes 11.

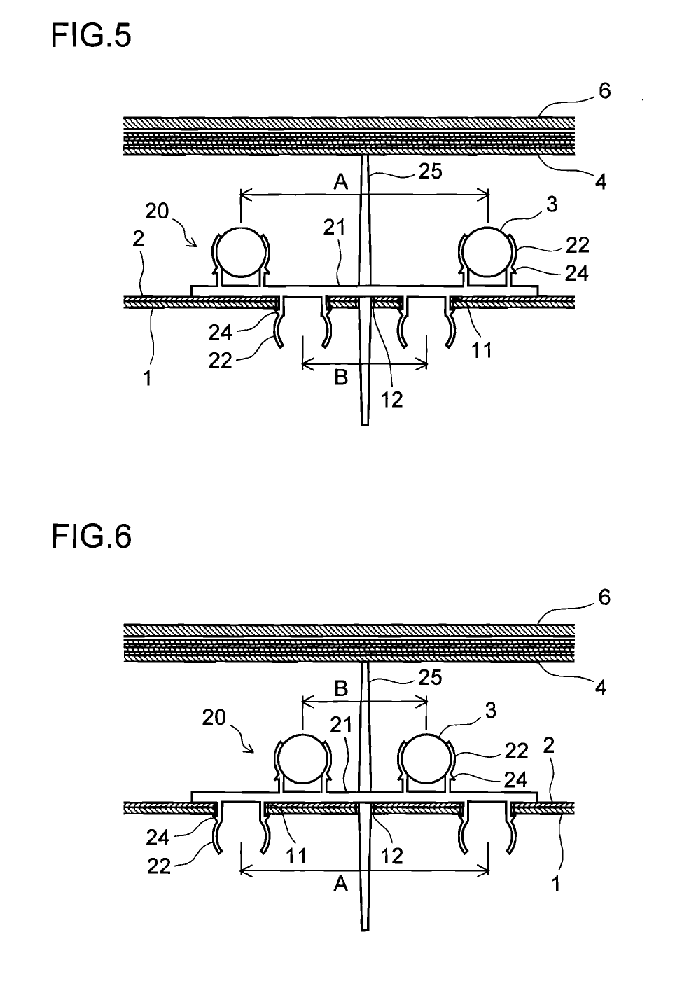

A second embodiment of the present invention is shown in FIGS. 5 and 6. The second embodiment is the first embodiment with the following modification applied. Specifically, at the center of either surface of a base 21 of a lamp clip 20, a support column 25 for supporting an optical sheet group 4 is formed. In a backlight chassis 1 and a reflector sheet 2, through holes 12 are formed for letting the support column 25 pass through.

Supporting the optical sheet group 4 with the support column 25 as described above helps keep appropriate distance between the optical sheet group 4 and the liquid crystal display panel 6, and reduce unevenness in images.

The position of the support column 25 is not limited to the center of the base 21. It may be located in another place. The number of the support column 25 is not limited to one on either surface of the base 21; it may be two or more. It is also possible to provide one on one surface and two or more on the other surface. Also, one surface may not be provided with the support column 25. In addition, the support column 25 may be formed integral with the base 21, or a separately formed member may be fitted to the base 21.

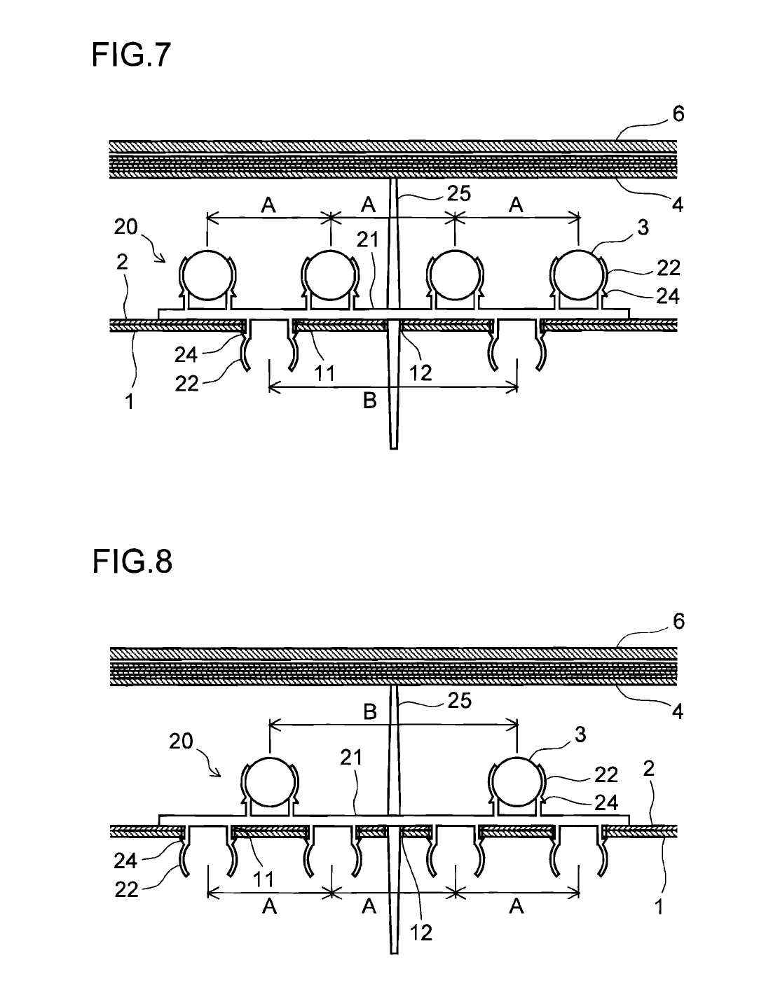

A third embodiment of the present invention is shown in FIGS. 7 and 8. The third embodiment is the second embodiment with the following modification applied. Specifically, on one surface of the base 21 of the lamp clip 20, four lamp grippers 22 are arranged in a row at intervals A; on the opposite surface of the base 21, two lamp grippers 22 are arranged at an interval B. The interval B is twice the interval A.

In a backlight adopting a setting in which light source lamps 3 are arranged at the intervals A, as shown in FIG. 7, there is used a combination of a backlight chassis 1 and a reflector sheet 2 that are provided with through holes 11 for letting lamp grippers 22 at the interval B pass through.

In a backlight adopting a setting in which light source lamps 3 are arranged at the interval B, as shown in FIG. 8, there is used a combination of a backlight chassis 1 and a reflector sheet 2 that are provided with through holes 11 for letting lamp grippers 22 at the intervals A pass through.

Differentiating the number of the lamp grippers 22 between the opposite surfaces of the base 21 of the lamp clip 20 as described above helps cope with both a backlight that requires a large number of light source lamps 3 and a backlight that does not require such a large number of light source lamps 3.

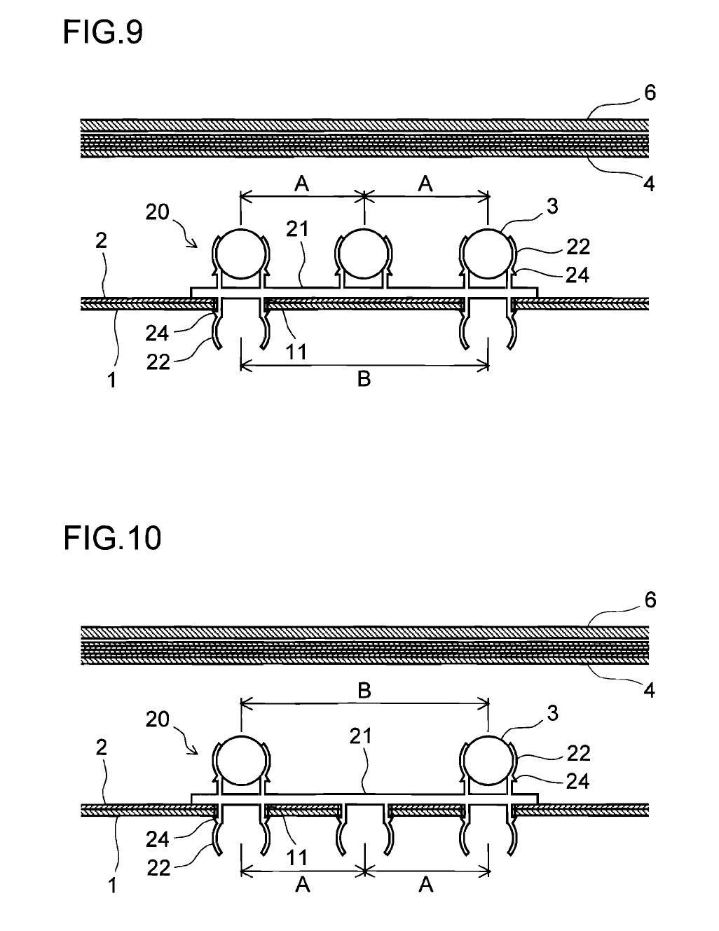

A fourth embodiment of the present invention is shown in FIGS. 9 and 10. In a lamp clip 20 according to the fourth embodiment, three lamp grippers 22 are arranged on one surface of the base 21, and two lamp grippers 22 are arranged on the opposite surface thereof. The former three lamp grippers 22 are arranged in a row at intervals A; the latter two lamp grippers 22 are arranged at an interval B twice the interval A. The latter two lamp grippers 22 are located symmetrically to the outermost two of the former three lamp grippers 22 with respect to the base 21.

In a backlight adopting a setting in which light source lamps 3 are arranged at the intervals A, as shown in FIG. 9, there is used a combination of a backlight chassis 1 and a reflector sheet 2 that are provided with through holes 11 for letting lamp grippers 22 at the interval B pass through.

In a backlight adopting a setting in which light source lamps 3 are arranged at the interval B, as shown in FIG. 10, there is used a combination of a backlight chassis 1 and a reflector sheet 2 that are provided with through holes 11 for letting lamp grippers 22 at the intervals A pass through.

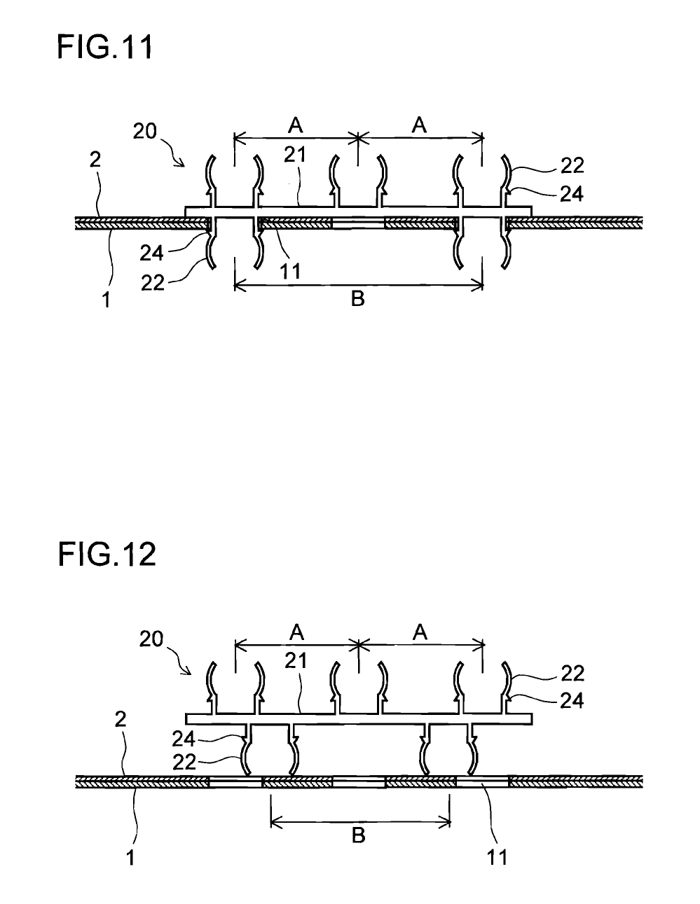

In the fourth embodiment, there is a point to consider. Specifically, when the interval B of the lamp grippers 22 on one surface is an integral multiple of the interval A of the lamp grippers 22 on the opposite surface, there may be a case in which the lamp clip 20 is fixed in a wrong orientation as shown in FIG. 11. The combination of the backlight chassis 1 and the reflector sheet 2 shown in FIG. 11 is the same as that shown in FIG. 10. Thus, three lamp grippers 22 at the intervals A are supposed to face down and be placed in three through holes 11. However, two lamp grippers 22 at the interval B are placed in the outermost through holes 11, and three lamp grippers 22 at the intervals A are facing up.

To prevent this, the interval B is deviated from the integral multiple of the interval A as shown in FIG. 12, so that the lamp grippers 22 at the interval B are prevented from entering the through holes 11 at the intervals A.

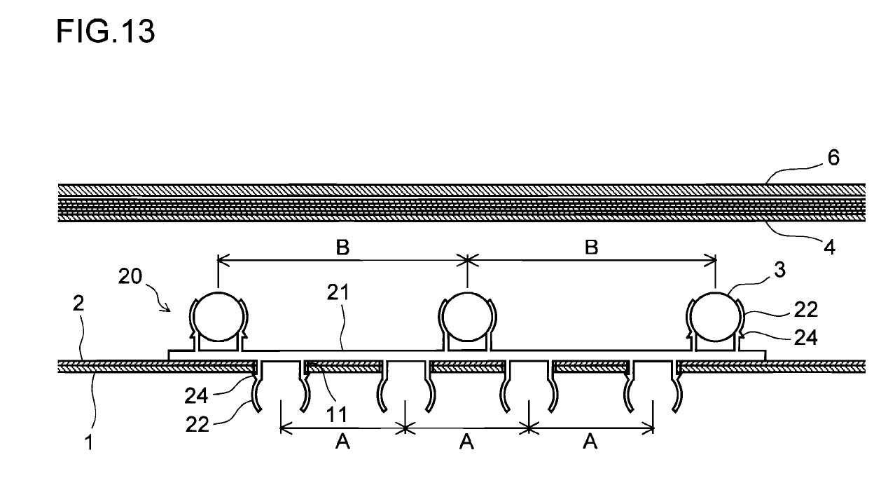

A fifth embodiment of the present invention is shown in FIG. 13. In a lamp clip 20 according to the fifth embodiment, four lamp grippers 22 are arranged on one surface of a base 21, and three lamp grippers 22 are arranged on the opposite surface. The former four lamp grippers 22 are arranged in a row at intervals A, and latter three lamp grippers 22 are arranged in a row at intervals B, the interval B being twice the interval A.

In the fifth embodiment, a point to consider is the arrangement of the engaging protrusions 24. Specifically, of the four lamp grippers 22 arranged at intervals A and of the three lamp grippers 22 arranged at intervals B, pairs of outermost two only have the engaging protrusions 24. Specifically, among the lamp grippers 22, those with the engaging protrusions 24 and those without them coexist.

As described above, with the structure in which, at either surface of the lamp clip 20, only two of the lamp grippers 22 have the engaging protrusion 24, it is not necessary to perform engaging work of the engaging protrusion 24 for all the lamp grippers 22 that pass through the through holes 11. By simply performing engaging work, at two places, whereby the engaging protrusions 24 are engaged with the edges of the through holes 11, it is possible to fix the lamp clip 20 to the backlight chassis 1. This speeds up the fixing work of the lamp clip. Moreover, with respect to the lamp grippers 22 without the engaging protrusions 24, there are advantages such as a simplified structure of a mold and reduction of molding material.

Among the lamp grippers 22 of three or more (three and four in the example shown in FIG. 13), it is not absolutely necessary to form the engaging protrusions 24 selectively on the outermost lamp grippers 22. There is no problem in forming the engaging protrusions 24 selectively in any two of the lamp grippers 22 regardless of “outermost”.

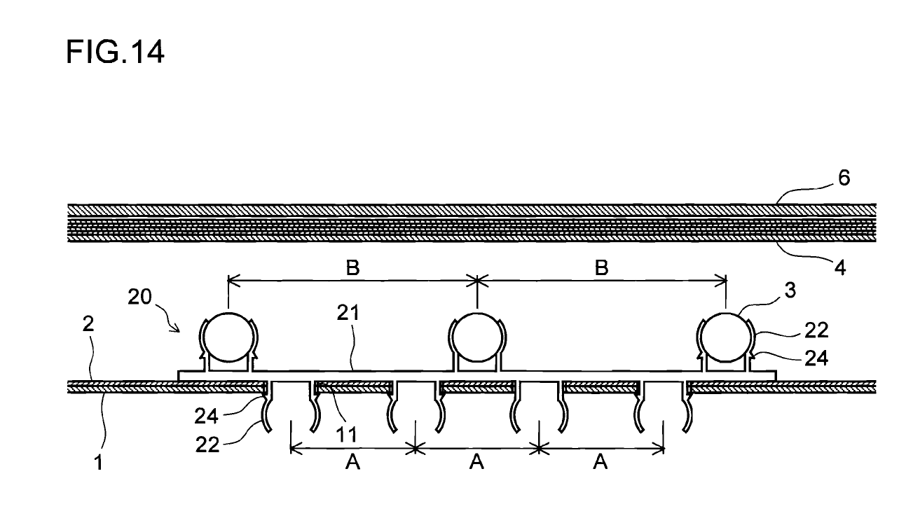

FIG. 14 shows a modified embodiment of the fifth embodiment. In FIG. 14, of four lamp grippers 22 arranged at an interval A, three are selected as forming sites of the engaging protrusions 24. The point is, so long as an object is achieved that the lamp clip 20 is surely fixed to the backlight chassis 1, there is no limitation to the number of the lamp grippers 22 on which the engaging protrusions 24 are formed. For example, it is also possible, by forming engaging protrusions 24 in only one of the four lamp grippers 22 at the intervals A or in one of the three lamp grippers 22 at the intervals B, to fit the lamp clip 20 simply by engaging the engaging protrusions 24 of the one lamp gripper 22 with the edge of the through hole 11.

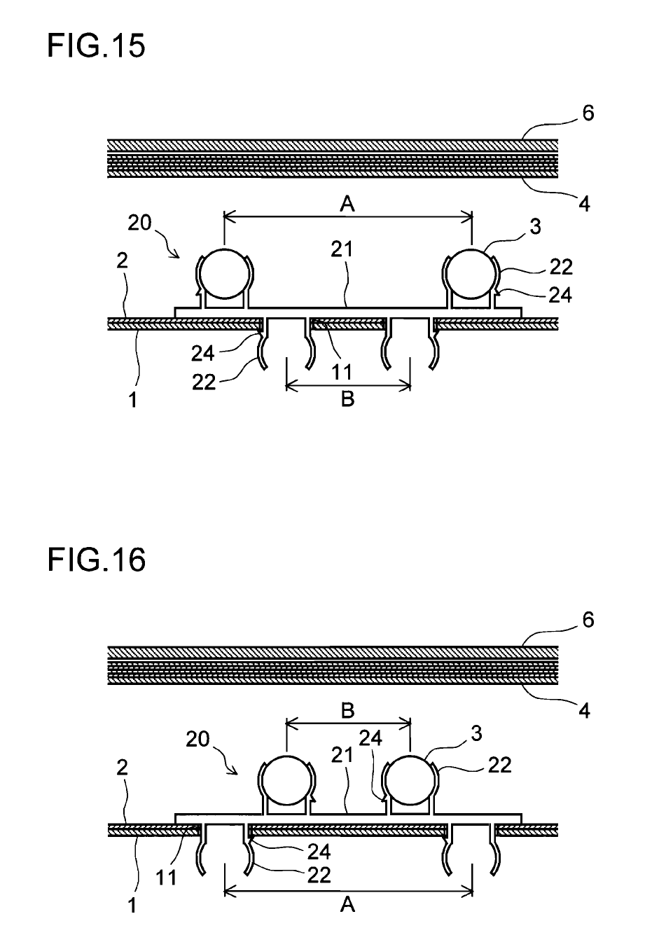

A sixth embodiment of the present invention is shown in FIG. 15. The sixth embodiment is the first embodiment with the following modification applied. Specifically, in the first embodiment, a pair of engaging protrusions 24 that face in opposite directions from each other is formed in each lamp grippers 22 of the lamp clip 20; however, in the sixth embodiment, each of the two lamp grippers 22 on each of opposite surfaces of the lamp clip 20 has one engaging protrusion 24 to form a pair of engaging protrusions 24, and each of the pair of protrusions 24 faces outward of the base 21, i.e., faces an opposite direction to that of the other of the pair.

In performing fixing of the lamp clip 20 by engaging the engaging protrusion 24 to the edge of a through hole 11 as described above, it is possible to fix the lamp clip 20 to the backlight chassis 1 by simply performing engaging work, at two places, whereby the engaging protrusions 24 are engaged with the edges of the through holes 11. This speeds up the fitting work of the lamp clip.

With the structure of the sixth embodiment, with respect to the lamp grippers 22 with the engaging protrusions 24, each lamp gripper 22 includes only one engaging protrusion 24. Thus, the structure of a mold is simplified, and molding material is reduced.

FIG. 16 shows a modified embodiment of the sixth embodiment. In FIG. 16, each of the two lamp grippers 22 on each of opposite surfaces of the lamp clip 20 has one engaging protrusion 24 to form a pair of engaging protrusions 24, and each of the pair of protrusions 24 faces the center of the base 21. The workings and benefits are similar to those of the structure shown in FIG. 15.

In the structures shown in FIGS. 15 and 16, each of the pair of protrusions 24 provided on two of the lamp grippers 22 on each of opposite surfaces of the lamp clip 20 faces an opposite direction to that of the other of the pair; however, it is also possible to adopt a structure in which the engaging protrusions 24 face the same direction.

Although FIGS. 15 and 16 show structures in which two lamp grippers 22 are provided on each of opposite surfaces of the lamp clip 20, it is also possible to apply the structure of the sixth embodiment to a lamp clip 20 that has three or more lamp grippers 22 on each surface thereof (for example, the lamp clips 20 according to the third embodiment to the fifth embodiments). In that case, the lamp grippers 22 each provided with one engaging protrusion 24 are not limited to a pair of the lamp grippers 22 located at the outermost. They can be any two lamp grippers 22.

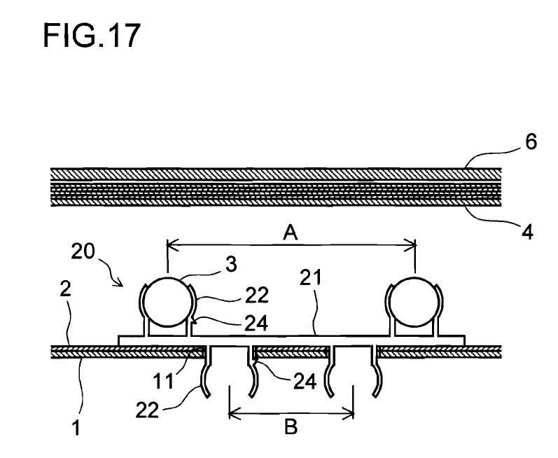

A seventh embodiment of the invention is shown in FIG. 17. In the seventh embodiment, a point to consider is the number of engaging protrusions 24. Specifically, only one engaging protrusion 24 is provided on any one of two lamp grippers 22 arranged at an interval A on one of the opposite surfaces of the base 21, and also on any one of two grippers 22 arranged at an interval B on the other of the opposite surfaces of the base 21. Even only one engaging protrusion 24, if properly designed, it sufficiently serves to prevent the lamp clip 20 from coming off the backlight chassis 1.

Although FIG. 17 shows a structure in which two lamp grippers 22 are formed on each of opposite surfaces of the lamp clip 20, needless to say that it is also possible to apply the structure of the seventh embodiment to a lamp clip 20 that has three or more lamp grippers 22 on each surface thereof.

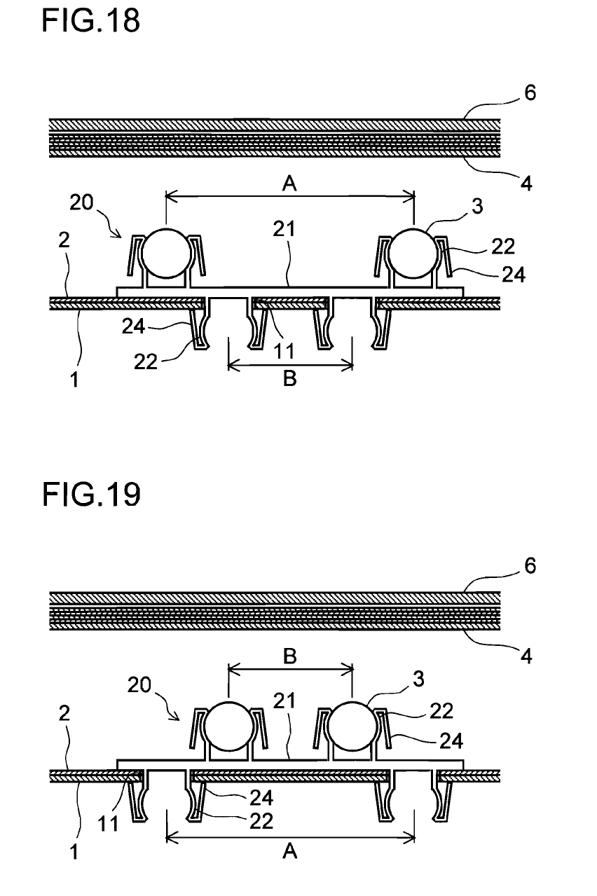

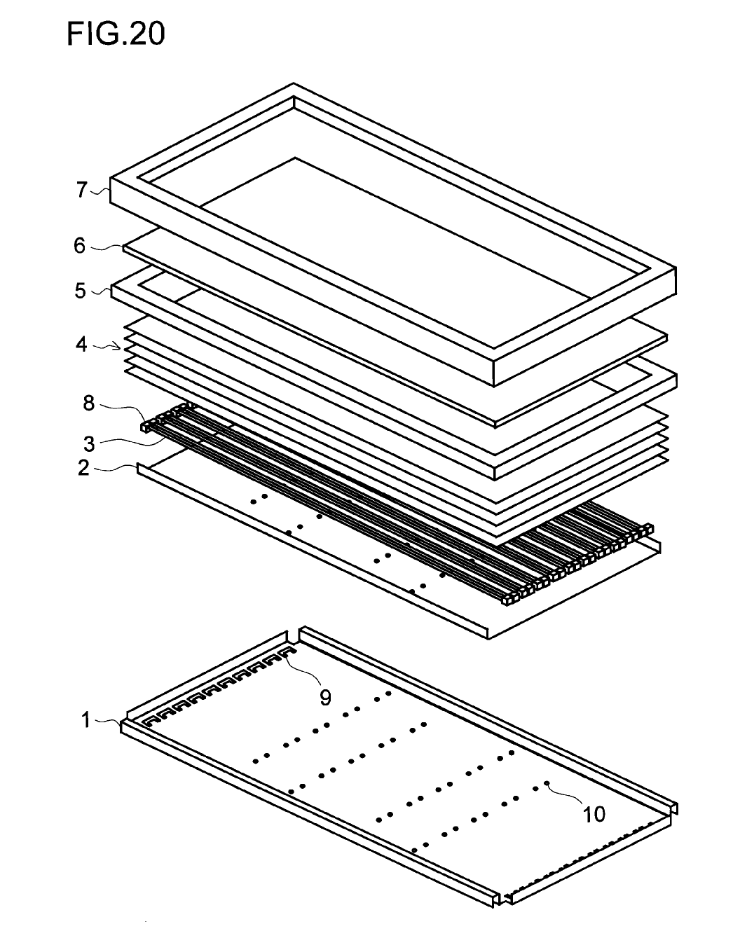

An eighth embodiment of the invention is shown in FIGS. 18 and 19. In a lamp clip 20 according to the eighth embodiment, an engaging protrusion 24 of a lamp gripper 22 is different from those in the first to seventh embodiments. Specifically, according to the first to seventh embodiments, the engaging protrusion 24 has the shape of a projection that projects outward from the border portion between the curved portion and the straight root portion of the arm of the lamp gripper 22; whereas according to the eighth embodiment, the engaging protrusion 24 has the shape of a tab that hangs down from the tip of the curved portion and faces the outside surface of the curved portion with a space in between. The distance from the tip of the engaging protrusion 24 to the base 21 is approximately equal to the thicknesses of the backlight chassis 1 and the reflector sheet 2 combined together.

The engaging protrusion 24 is flexed inward to pass through a through hole 11, and after passing therethrough, it opens outward. In this state, the tip of the engaging protrusion 24 makes contact with a surface of the backlight chassis 1, and the base 21 does not come off from the backlight chassis 1.

The engaging protrusion 24 is not necessarily indispensable for fixing the lamp clip 20. It is also possible to adopt a structure in which the curved portion of the lamp gripper 22 is engaged with the edge of the through hole 11 so that the lamp clip 20 is prevented from coming off the backlight chassis 1.

The embodiments of the present invention are described above, and it is to be understood that many other modifications and variations are possible within the scope of the present invention.

### INDUSTRIAL APPLICABILITY

The present invention finds wide application in liquid crystal display devices that uses straight tube light source lamps as a backlight.

1. A backlight for a liquid crystal display device, in which a straight tube light source lamp arranged at a surface of a backlight chassis is held by a lamp clip fixed to the backlight chassis,
wherein the lamp clip includes a base placed on a surface of the backlight chassis, and a lamp gripper formed on each of opposite surfaces of the base;
wherein a plurality of the lamp grippers are respectively formed on each of the opposite surfaces of the base at respective intervals that differ depending on which surface the lamp grippers belong to;
wherein, in the backlight chassis, there are formed through holes for letting pass therethrough the lamp grippers on one of the opposite surfaces of the lamp clip, the surface being the one that does not take part in lamp holding; and
wherein the lamp grippers that have passed through the through holes serve to fix the lamp clip to the backlight chassis.

2. The backlight for a liquid crystal display device according to claim 1,
wherein the lamp grippers are provided in different numbers between each of the opposite surfaces of the base.

3. The backlight for a liquid crystal display device according to claim 1,
wherein an engaging protrusion is formed on at least one of the lamp grippers that pass through the through holes, and
wherein, by the engaging protrusion being engaged with an edge of the through holes, the lamp clip is fixed to the backlight chassis.

4. The backlight for a liquid crystal display device according to claim 3,
wherein, among the lamp grippers that pass through the through holes, the lamp grippers with the engaging protrusion and the lamp grippers without the engaging protrusion coexist.

5. The backlight for a liquid crystal display device according to claim 3,
wherein, with respect to the lamp grippers having the engaging protrusion, each of the lamp grippers includes two engaging protrusions, and
wherein the two engaging protrusions project in opposite directions from each other.

6. The backlight for a liquid crystal display device according to claim 3,
wherein, with respect to the lamp grippers having the engaging protrusion, each of the lamp grippers includes one engaging protrusion.

7. The backlight for a liquid crystal display device according to claim 1,
wherein a support column for supporting an optical sheet group arranged at a rear of a liquid crystal display panel is formed on one or both of the opposite surfaces of the base.

8. The backlight for a liquid crystal display device according to claim 2,
wherein an engaging protrusion is formed on at least one of the lamp grippers that pass through the through holes, and
wherein, by the engaging protrusion being engaged with an edge of the through holes, the lamp clip is fixed to the backlight chassis.

9. The backlight for a liquid crystal display device according to claim 8,
wherein, among the lamp grippers that pass through the through holes, the lamp grippers with the engaging protrusion and the lamp grippers without the engaging protrusion coexist.

10. The backlight for a liquid crystal display device according to claim 8,
wherein, with respect to the lamp grippers having the engaging protrusion, each of the lamp grippers includes two engaging protrusions, and
wherein the two engaging protrusions project in opposite directions from each other.

11. The backlight for a liquid crystal display device according to claim 8,
wherein, with respect to the lamp grippers having the engaging protrusion, each of the lamp grippers includes one engaging protrusion.
